(19) United States
(12) Patent Application Publication
(10) Pub. No.: US 2012/0052213 A1
(43) Pub. Date: Mar. 1, 2012

(54) METHOD FOR RECOATING DOUBLE CLAD OPTICAL FIBER

(75) Inventor: Yoshihiro TERADA, Sakura-shi (JP)

(73) Assignee: FUJIKURA LTD., Tokyo (JP)

(21) Appl. No.: 12/980,992

(22) Filed: Dec. 29, 2010

Related U.S. Application Data
(60) Provisional application No. 61/379,068, filed on Sep. 1, 2010.

(51) Int. Cl. B05D 3/06; G02B 6/02

(52) U.S. Cl. 427/554; 427/163.2

(57) ABSTRACT

A method for recoating a double clad optical fiber having a core, a first cladding layer that surrounds the core, and a coating layer that covers the first cladding layer, in which the coating layer includes a second cladding layer that surrounds the first cladding layer, the method including: a step of removing the coating layer and exposing the first cladding layer; and a step of applying a curable resin on top of the exposed first cladding layer under reduced pressure, followed by curing of the curable resin under normal pressure, thereby forming a recoat layer.

### CROSS-REFERENCE TO RELATED APPLICATION

This application is a non-provisional application claiming priority to and the benefit of U.S. provisional application No. 61/379,068, filed Sep. 1, 2010. The entire contents of which are incorporated herein by reference.

### BACKGROUND

1. Field of the Invention

The present invention relates to a method for recoating a double clad optical fiber, the method for recoating a portion, from which a second cladding layer and a protective coating layer have been removed, so as to obtain a double clad optical fiber exhibiting a reduced loss of light.

2. Description of Related Art

A single clad optical fiber has a cladding layer that surrounds a core, and typical examples thereof include an optical fiber shown in FIG. 12. FIG. 12 is a cross sectional diagram showing an example of a single clad optical fiber in the radial direction. A single clad optical fiber 9 shown here is mainly constituted of a core 91, a cladding layer 92 that surrounds the core 91, a first protective coating layer 93 that surrounds the cladding layer 92, and a second protective coating layer 94 that surrounds the first protective coating layer 93. In such a single clad optical fiber, the intensity of propagating light is usually extremely low in the vicinity of the surface of a cladding layer made of quartz glass. Accordingly, even if a foreign material is present in the interface between the cladding layer 92 and the first protective coating layer 93 or in the vicinity thereof, the extent of the loss of propagating light due to scattering is not great. Consequently, in the single clad optical fiber 9 where coatings (i.e., the first protective coating layer 93 and the second protective coating layer 94) have been removed, during the recoating process in which the exposed cladding layer 92 is coated with a resin and is therefore recoated, an optical fiber exhibiting superior light characteristics can be obtained even if a foreign material is present in the surface of the cladding layer 92 or in the vicinity thereof. Examples of the method for recoating a single clad optical fiber include a molding method (refer to Japanese Unexamined Patent Application, First Publication No. 2003-128440), a die method (refer to Japanese Unexamined Patent Application, First Publication No. H09-043446) and a casting method (refer to Japanese Unexamined Patent Application, First Publication No. S60-103053).

On the other hand, FIG. 1 is a cross sectional diagram showing an example of a double clad optical fiber in the radial direction. A double clad optical fiber 1 shown here is mainly constituted of a core 11, a first cladding layer 12 that surrounds the core 11, a second cladding layer 13 that surrounds the first cladding layer 12, and a protective coating layer 14 that surrounds the second cladding layer 13. Usually, the core 11 and the first cladding layer 12 consist primarily of quartz glass, and the second cladding layer 13 and the protective coating layer 14 consist primarily of a cured product of a curable resin. In the double clad optical fiber 1, first propagating light propagates through the core 11 while second propagating light propagates through the core 11 and the first cladding layer 12, respectively. However, the intensity of propagating light is high in the vicinity of the surface 12a of the first cladding layer 12. Accordingly, if a foreign material is present in the interface between the first cladding layer 12 and the second cladding layer 13 or in the vicinity thereof, the second propagating light is scattered, and as a result, a great extent of optical loss easily occurs.

FIG. 2 is a cross sectional diagram of the double clad optical fiber 1 passing through the central axis thereof in the longitudinal direction.

Here, by removing the second cladding layer 13 and the protective coating layer 14 within a portion of the double clad optical fiber 1, a coating-removed portion 10 in which the first cladding layer 12 is exposed is formed in the removed portion of the double clad optical fiber 1. In the coating-removed portion 10, the reference symbol 13a denotes the exposed end of the second cladding layer 13, and the reference symbol 14a denotes the exposed end of the protective coating layer 14.

In general, in the coating-removed portion 10, a foreign material 8 is present in the surface 12a of the first cladding layer in many cases. This is because when the second cladding layer 13 and the protective coating layer 14 are removed, the resin residues originating from either one or both of these layers tend to remain without being removed. In addition, the exposed end 13a of the second cladding layer tends to degenerate, and the surface thereof is easily roughened.

Here, the loss of second propagating light in the coating-removed portion 10 will be described.

FIG. 13A and FIG. 13B are cross sectional diagrams showing an enlarged view of the coating-removed portion 10 in FIG. 2, which is recoated with a resin by a conventional method. FIG. 13A shows the surface 12a of the first cladding layer and the vicinity thereof, and FIG. 13B shows the exposed end 13a of the second cladding layer and the vicinity thereof, respectively.

First, as shown in FIG. 13A, a case where a foreign material 8 is present in the surface 12a of the first cladding layer will be described. Complex irregularities are usually present in the surface of the foreign material 8, and when a curable resin is applied in the coating-removed portion 10, the curable resin hardly flows into a recessed portion 80 and gases such as air tend to remain therein. When the curable resin is cured in this state, the recoating process is completed while the gases remain confined within the recessed portion 80. As a result, a void portion 7 will be incorporated in the surface 12a of the first cladding layer within a recoat layer 15. Then, the second propagating light is scattered by the void portion 7, thereby causing a great extent of optical loss.

Next, as shown in FIG. 13B, a case where the exposed end 13a of the second cladding layer has a rough surface will be described. Complex irregularities are present in the exposed end 13a, and when a curable resin is applied in the coating-removed portion 10, the curable resin hardly flows into a recessed portion 130 and gases tend to remain therein. When the curable resin is cured in this state, as described above, the recoating process is completed while the gases remain confined within the recessed portion 130. As a result, a void portion 7 will be incorporated in the second cladding layer 13. In those cases where the void portion 7 is present in the vicinity of the surface 12a of the first cladding layer, the second propagating light is scattered by the void portion 7, thereby causing a great extent of optical loss. It should be noted that since the exposed end 14a of the protective coating layer is present at a position which is distant from the surface 12a of the first cladding layer, it does not usually cause any problems even if the end has a rough surface.

### SUMMARY

As described above, in the double clad optical fibers, a void portion is incorporated in the surface of the first cladding layer or in the vicinity thereof, thereby causing a great extent of optical loss. This is a problem which is unique to the double clad optical fibers and is absent in the single clad optical fibers. Since the same recoating method has conventionally been applied to the double clad optical fibers as that employed for the single clad optical fibers, there has been no recoating method available which is effective in solving the above-mentioned problem.

The present invention is made in view of the above-mentioned circumstances and its object is to provide a method for recoating a double clad optical fiber by forming a recoat layer while suppressing the incorporation of void portions so as to reduce the loss of light.

In order to solve the above-mentioned problems, the present invention employs the following. In particular, a method for recoating a double clad optical fiber according to an aspect of the present invention has a core, a first cladding layer that surrounds the core, and a coating layer that covers the first cladding layer, in which the coating layer includes a second cladding layer that surrounds the first cladding layer, the method including: a step for of removing the coating layer and exposing the first cladding layer; and a step for of applying a curable resin on top of the exposed first cladding layer under reduced pressure, followed by curing of the curable resin under normal pressure, thereby forming a recoat layer.

In the above-described method for recoating a double clad optical fiber, it may be arranged such that the curable resin is applied on top of the first cladding layer while heating the curable resin at a temperature so as not to degrade or degenerate.

In addition, in the above-described method for recoating a double clad optical fiber, it may be arranged such that the curable resin is cured while measuring a loss of a propagating light in the first cladding layer.

Further, in the above-described method for recoating a double clad optical fiber, it may be arranged such that the coating layer is removed by laser irradiation.

Moreover, in the above-described method for recoating a double clad optical fiber, it may be arranged such that the coating layer is removed while cooling to a temperature at which the second cladding layer does not degenerate.

Furthermore, in the above-described method for recoating a double clad optical fiber, it may be arranged such that the curable resin is an ultraviolet curable resin and the second cladding layer be formed by curing an ultraviolet curable resin.

Also, in the above-described method for recoating a double clad optical fiber, it may be arranged such that the recoat layer is formed by a molding method, a die method or a casting method.

### BRIEF DESCRIPTION OF THE DRAWINGS

FIG. 1 is a cross sectional diagram showing an example of a double clad optical fiber in the radial direction.

FIG. 2 is a cross sectional diagram of a double clad optical fiber passing through the central axis thereof in the longitudinal direction.

FIG. 3 is a schematic diagram for explaining a step of removing a coating layer of a double clad optical fiber by laser irradiation.

FIG. 4 is a schematic diagram for explaining a step of removing a coating layer of a double clad optical fiber by blowing hot air.

FIG. 5 is a schematic diagram showing a state where a double clad optical fiber is installed to a cooling device via a heat conductor in order to cool the double clad optical fiber.

FIGS. 6A to 6C are enlarged cross sectional diagrams of a coating-removed portion for explaining a recoating step, taken in a plane including the central axis of the double clad optical fiber. FIG. 6A is an enlarged cross sectional diagram at the time of applying a curable resin under reduced pressure, FIG. 6B is an enlarged cross sectional diagram prior to curing of the curable resin under normal pressure, and FIG. 6C is an enlarged cross sectional diagram following curing of the curable resin.

FIG. 7 is a schematic configuration diagram showing a measuring system for measuring the loss of light in the double clad optical fiber.

FIG. 8 is a schematic diagram for explaining a step of forming a recoat layer by employing a die method.

FIGS. 9A to 9D are schematic diagrams for explaining a step of forming a recoat layer by employing a molding method.

FIG. 10 is a schematic configuration diagram showing a cladding pumped fiber laser prepared by employing the recoating method according to an embodiment of the present invention.

FIG. 11 is a graph showing a relationship between the time of irradiating UV light onto an ultraviolet curable resin and the loss of propagating light in the first cladding layer during the recoating step of Example 19.

FIG. 12 is a cross sectional diagram showing an example of a single clad optical fiber in the radial direction.

FIG. 13A and FIG. 13B are cross sectional diagrams showing an enlarged view of the coating-removed portion in FIG. 2, which is recoated with a resin by a conventional method. FIG. 13A shows the surface of the first cladding layer and the vicinity thereof, and FIG. 13B shows the exposed end of the second cladding layer and the vicinity thereof, respectively.

### MODE FOR CARRYING OUT THE INVENTION

The following text explains an embodiment of the present invention referencing the drawings, but the present invention is not limited thereto. The method for recoating a double clad optical fiber according to the embodiment of the present invention is a method for recoating a double clad optical fiber having a core, a first cladding layer that surrounds the core, and a coating layer that covers the first cladding layer, in which the coating layer includes a second cladding layer that surrounds the first cladding layer, the method including a step of removing the coating layer and exposing the first cladding layer (hereafter, abbreviated as a removal step); and a step of applying a curable resin on top of the exposed first cladding layer under reduced pressure, followed by curing of the curable resin under normal pressure, thereby forming a recoat layer (hereafter, abbreviated as a recoating step).

In the present embodiment, the term “recoating” refers to a process in which a coating layer is removed, a resin is applied (resin coating is performed) on the exposed first cladding layer, and the resin is cured so as to provide a coating once again. In addition, the term “coating layer” refers to a layer as a whole, which is covering the first cladding layer, including not only the protective coating layer but also the second cladding layer. Further, the term “degeneration” refers to a “loss of intrinsic properties”.

As a method for coating an optical fiber with a curable resin, for example, a method has been known in which a curable resin is applied on an optical fiber under reduced pressure to cure. This method has an object of removing gas which is incorporated or dissolved within the resin prior to curing so as to prevent air bubbles from remaining within the cured resin. This method is employed for coating an optical fiber at the time of producing the optical fiber immediately after fiber drawing, and since the recoating of resin is not particularly considered, even if employed directly for recoating the double clad optical fiber, the loss of propagating light cannot be necessarily reduced.

In contrast, the method according to the embodiment of the present invention not only removes gas which is incorporated or dissolved within the resin prior to curing but, even if a foreign material is present on the surface of the first cladding layer or in the vicinity thereof, or if the exposed end of the second cladding layer has a rough surface, also eliminates the void portion of the site, thereby obtaining a double clad optical fiber in which the loss of propagating light is reduced.

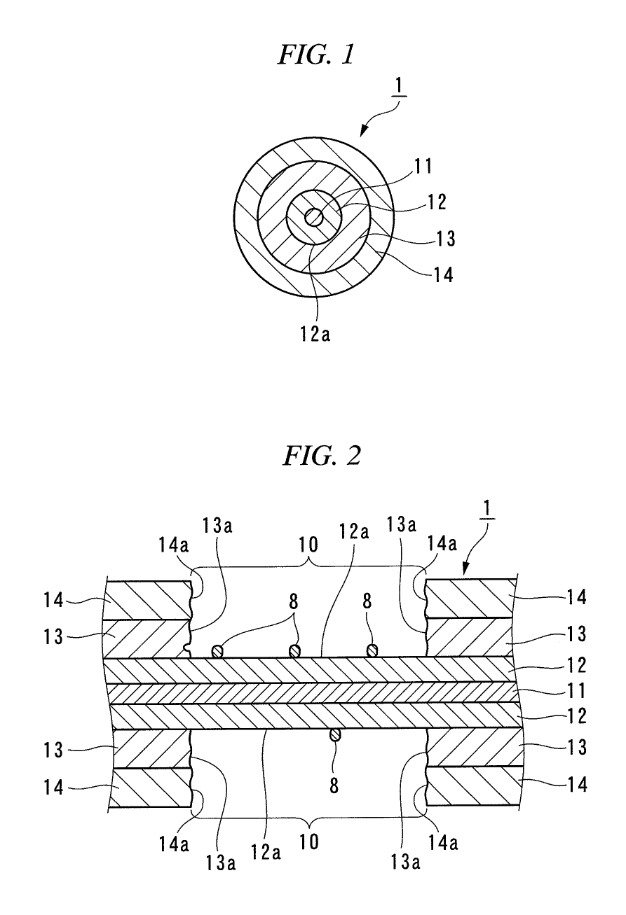

A double clad optical fiber provided for the recoating process may be a known double clad optical fiber; i.e., a double clad optical fiber having a core, a first cladding layer, a second cladding layer and a protective coating layer. Examples thereof include a double clad optical fiber in which the core and the first cladding layer consist primarily of quartz glass, and the coating layer consist primarily of a cured product of a curable resin, as shown in FIG. 1. Examples of the curable resin for forming a coating layer include a photocurable resin and a thermosetting resin which are the same curable resins as those for forming a recoat layer to be described later. Since the second cladding layer, among the coating layers, can be cured within a short period of time and also exhibits superior light characteristics, it is preferable to use a photocurable resin therefor, and an ultraviolet curable resin is more preferable. Note that the second cladding layer is prepared so as to exhibit a refractive index which is lower than that of the first cladding layer.

### (Removal Step)

In the removal step, the coating layers of a double clad optical fiber are removed, thereby exposing the first cladding layer.

The coating layers may be removed at least at a portion, with respect to the central axis direction, of a double clad optical. In addition, a portion of or the entirety, with respect to the outer circumferential direction, of double clad optical fiber may be removed.

A case where the entire coating layer is removed in the outer circumferential direction by using a double clad optical fiber shown in FIG. 1 to expose the first cladding layer as shown in FIG. 2 will be described below. However, also in other cases, the coating layer can be removed in the same manner.

A second cladding layer 13 and a protective coating layer 14 serving as the coating layers may be removed by a known method. Among the known methods, examples of particularly preferred methods include: (a) a removal by laser irradiation; (b) a removal by blowing hot air; and (c) a removal by cutting using a cutting tool such as a knife or a razor blade (hereafter, abbreviated as the “removal by cutting tools”). More specific explanations therefor are as follows.

### (a) Removal by Laser Irradiation

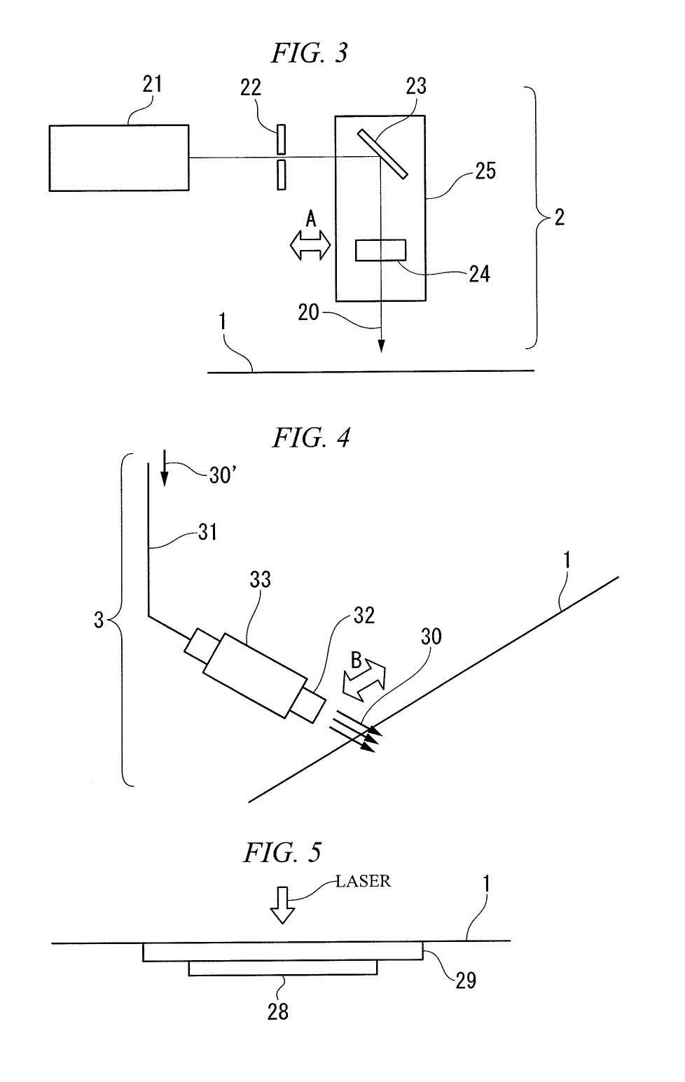

FIG. 3 is a schematic diagram for explaining a step of removing a coating layer by laser irradiation.

A laser irradiating apparatus 2 exemplified herein includes a laser oscillator 21, a slit 22, a mirror 23, a lens 24 and a stage 25. Moreover, the stage 25 is configured so as to be movable along the longitudinal direction of a fixed double clad optical fiber 1 (i.e., the direction indicated by the arrow A).

It is configured so that laser 20 oscillated from the laser oscillator 21 passes through the slit 22, reaches the mirror 23 to be reflected so as to alter the direction thereof, is collected by the lens 24, and is then irradiated onto a predetermined portion in the double clad optical fiber 1 for a predetermined period of time. The mirror 23 and the lens 24 are installed on the stage 25 so as to move, when the stage 25 is moved. As a result, it is configured so that the portion irradiated by the laser 20 can be moved along the longitudinal direction of the fixed double clad optical fiber 1, thereby easily adjusting the length of the coating-removed portion 10. The traveling distance of the stage 25 substantially equals to the length of the coating-removed portion 10. In addition, it is configured so that the double clad optical fiber 1 is rotated in the outer circumferential direction thereof and fixed while the direction thereof being altered, thereby enabling alteration of the portion which is irradiated by the laser 20.

It should be noted that the laser irradiating apparatus shown herein is merely an example, and an apparatus of any configuration may be adopted as long as the removal of the coating layers is possible.

The types of laser and the irradiation conditions thereof may be appropriately adjusted depending on the type of a coating layer to be removed. Examples thereof include an infrared laser, a visible light laser, an ultraviolet laser and an X ray laser. The media therefor are not particularly limited either, and any one of solid lasers such as ruby lasers, and YAG lasers; liquid lasers; gas lasers such as carbonate gas lasers, helium neon lasers, argon gas lasers, and excimer lasers; semiconductor lasers and free electron lasers may be used, and these may be irradiated under the conditions suitable for removing the coating layer. Of these, excimer lasers such as KrF and ArF and argon gas lasers are particularly preferred.

### (b) Removal by Blowing of Hot Air

FIG. 4 is a schematic diagram for explaining a step of removing a coating layer by blowing hot air.

A hot air blowing apparatus 3 exemplified herein includes a nozzle 32, a piping 31 that sends a compressed air 30′ sent from a compressor (not shown) to the nozzle 32, and a heater 33 provided to the nozzle 32 for heating the compressed gas blown from the nozzle 32 to form hot air 30. Moreover, the nozzle 32 is configured so as to be movable along the longitudinal direction of a fixed double clad optical fiber 1 (i.e., the direction indicated by the arrow B).

It is configured so that the hot air 30 sent from the nozzle 32 can be blown to a predetermined portion of the double clad optical fiber 1 by adequately setting the direction of the nozzle 32. In addition, it is configured so that, by moving the nozzle 32, the portion blown by the hot air 30 can be moved along the longitudinal direction of the fixed double clad optical fiber 1, thereby easily adjusting the length of the coating-removed portion 10. The traveling distance of the nozzle 32 substantially equals the length of the coating-removed portion 10. Further, as in the case of laser irradiation as described above, it is configured so that the double clad optical fiber 1 is rotated in the outer circumferential direction thereof and fixed while the direction thereof with respect to the nozzle 32 being altered, thereby enabling alteration of the portion in the double clad optical fiber 1 which is blown by the hot air 30.

It should be noted that the hot air blowing apparatus shown herein is merely an example, and an apparatus of any configuration may be adopted as long as the removal of the coating layers is possible.

In terms of the type of gas for the hot air, an inert gas is preferred and nitrogen gas is particularly preferred in order to suppress the degeneration of coating layer.

Although the hot air flow rate is not particularly limited as long as the coating layer can be removed, it is preferable to adjust it in accordance with the inner diameter of the nozzle 32. For example, when the inner diameter of the nozzle 32 is from 1 to 7 mm, the hot air flow rate is preferably from 100 to 400 L/min.

Among various possibilities described above, the method (a) (i.e., the removal by laser irradiation) is preferred since the operation is simple, the removal effect is high, and superior effects of suppressing the generation of resin residues or the like can be attained. In laser irradiation, the second cladding layer 13 and the protective coating layer 14 can be removed due to the ablation effects.

In the removal step, it is preferable to remove the coating layer while cooling the coating layer to a temperature at which the second cladding layer does not degenerate. As a result, degeneration of the second cladding layer 13, especially at the exposed end 13a of the second cladding layer, can be suppressed, and fluctuation in the refractive index of the coating layer can also be suppressed. Moreover, even if the foreign material 8 originating from the second cladding layer is produced and remains in the surface 12a of the first cladding layer or in the vicinity thereof, since this foreign material 8 is not degenerated, the refractive index and the like remain equal to those of the second cladding layer 13. Accordingly, in those cases where a recoat layer is formed using the same curable resin as that used for formation of the second cladding layer 13 and the protective coating layer 14, the recoat layer exhibits the same optical properties to those of the second cladding layer 13 and the protective coating layer 14. Therefore, propagating light can be confined effectively, and the effect of suppressing the loss of propagating light can be enhanced even further.

In order to suppress the degeneration of the second cladding layer, the temperature of the second cladding layer may be adjusted to a temperature which is lower than the temperature at which the second cladding layer degenerate, and the cooling thereof is preferred. Although the temperature to be achieved by the adjustment at this time differs depending on the type of second cladding layer and thus cannot be generalized, for example, a temperature of 200° C. or less is preferred in the case of a second cladding layer formed using a fluorinated acrylate resin. Further, by cooling to a temperature lower than the glass transition temperature of the resin which is forming the second cladding layer, a high degree of effects to suppress the degeneration of the second cladding layer can be attained.

Examples of the method for cooling the coating layer include a method to immerse the target portion of a double clad optical fiber in a refrigerant, a method to place the target portion on top of a cooling device, and a method to blow a cold air to the target portion, an appropriate method may be selected in accordance with the method for removing the coating layer.

In the case of immersing the target portion in a refrigerant, for example, an optical fiber may be immersed in a refrigerant together with the fixing device by which this optical fiber is fixed.

In those cases where the coating layer is removed by laser irradiation, laser may be directly irradiated onto the target portion of the optical fiber in a refrigerant. Further, when irradiating an excimer laser, the coating layer can stably be removed if the excimer laser is irradiated from the direction which is substantially perpendicular with respect to the liquid surface of the refrigerant. Further, the coating layer can stably be removed if the target portion of the optical fiber is immersed in a manner so that the depth of surface of the coating layer from the liquid surface is about 5 mm or less.

Preferred examples of the refrigerant include liquid nitrogen.

In the case of placing the target portion on top of a cooling device, the target portion may be placed so as to be brought into direct contact with the cooling device or may be placed via a heat conductor, such as a metal or an alloy.

FIG. 5 is a schematic diagram showing a state where the double clad optical fiber 1 is installed to a cooling device 28 via a plate-like heat conductor 29. In those cases where a heat conductor is interposed, as shown here, the double clad optical fiber 1 can be cooled efficiently by employing a plate-like heat conductor.

Preferred examples of the cooling device include a Peltier device.

In the case of blowing a cold air to the target portion, it is preferable to stabilize the blown portion by employing a fan or a nozzle. In addition, it is necessary to fix the double clad optical fiber, and it is preferable to apply a tension of, for example, about 40 to 200 gf, more preferably about 150 gf. By doing so, swinging of the optical fiber can be prevented, and the coating layer can be stably removed.

The type of cold air gas is not particularly limited, and may be selected appropriately from amongst the available gases, such as air and nitrogen. In particular, an inert gas is preferred, and nitrogen, argon, helium or the like is preferred. Since chemical reactions between the components of the coating layer and the cold air gas can be suppressed by employing an inert gas, the reaction products do not attach to the surface of the first cladding layer or the vicinity thereof.

The cold air flow rate is not particularly limited as long as the cooling effects are achieved.

By removing the coating layer (i.e., the second cladding layer 13 and the protective coating layer 14) in this manner, a portion of the surface 12a of the first cladding layer is exposed, as shown in FIG. 2.

It should be noted that in FIG. 2, as a double clad optical fiber from which the coating layer has been removed, the double clad optical fiber in which the foreign material 8 is present in the surface 12a of the first cladding layer and also the exposed end 13a of the second cladding layer has a rough surface is shown. However, there are cases where only one of these conditions are satisfied, and there are also cases where the foreign material 8 is present in the surface of the exposed end 13a of the second cladding layer.

### (Recoating Step)

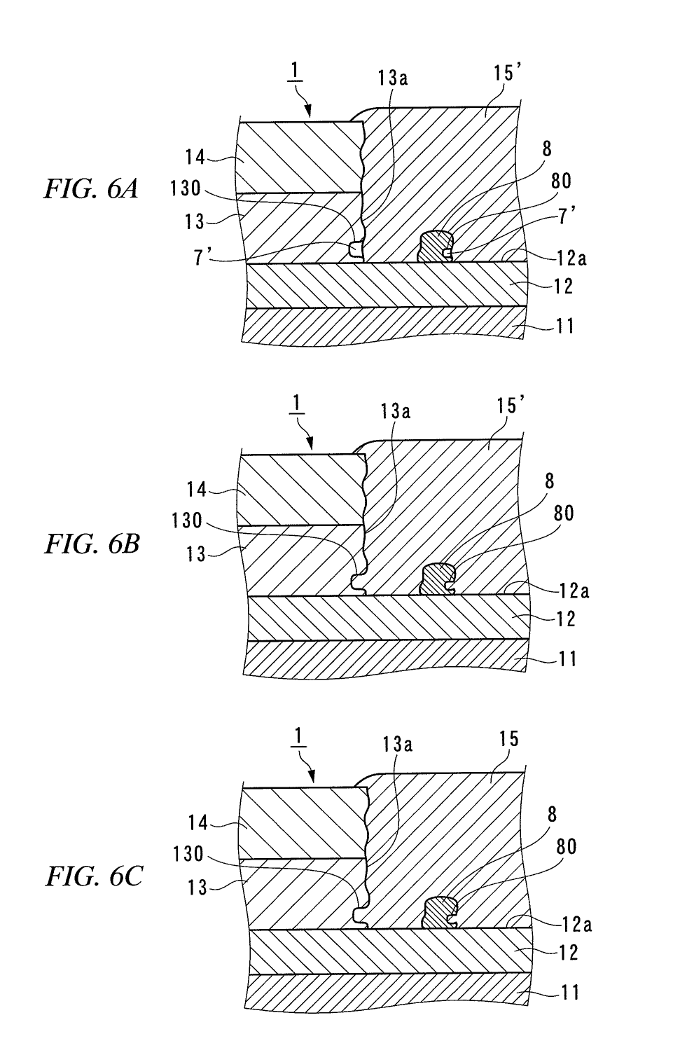

The recoating step is carried out following the removal step. FIGS. 6A to 6C are enlarged cross sectional diagrams of a coating-removed portion for explaining a recoating step, taken in a plane including the central axis of the double clad optical fiber 1. FIG. 6A is an enlarged cross sectional diagram at the time of applying a curable resin under reduced pressure, FIG. 6B is an enlarged cross sectional diagram prior to curing of the curable resin under normal pressure, and FIG. 6C is an enlarged cross sectional diagram following curing of the curable resin.

In the recoating step, a curable resin 15′ is first applied on top of the exposed first cladding layer 12 under reduced pressure. At this stage, as shown in FIG. 6A, the curable resin 15′ hardly flows into a recessed portion 80 in the surface of the foreign material 8 or a recessed portion 130 in the exposed end 13a of the second cladding layer, thereby forming a void portion 7′ at times. In other words, a mere application of the curable resin 15′ under reduced pressure cannot completely suppress the occurrence of the void portion 7′.

The curable resin 15′ is provided for the sake of forming a recoat layer, and any of the known resins, such as a photocurable resin and a thermosetting resin, may be selected depending on the purpose. Usually, it is preferable to use a resin capable of forming a layer having the same refractive index as that of the second cladding layer 13, and it is more preferable to use a resin capable of forming the same layer as the second cladding layer 13. By doing so, scattering of the propagating light can be suppressed, and the effect of reducing the loss of light can be enhanced even further. As the curable resin 15′, a photocurable resin is preferred, and an ultraviolet curable resin is more preferred, since it can be cured within a short period of time and also exhibits superior light characteristics.

The method for applying the curable resin 15′ is not particularly limited as long as it can be carried out under reduced pressure, and can be selected from known methods depending on the purpose. More specifically, although a dipping method, an applying method using a brush, or the like may be employed, preferred examples include (i) a die method, (ii) a molding method, and (iii) a casting method.

Although the pressure at the time of applying the curable resin 15′ under reduced pressure is preferably as low as possible, more specifically, the pressure is preferably 100 Pa or less, more preferably 50 Pa or less, and particularly preferably 20 Pa or less. The lower limit for the pressure is not particularly limited, and the pressure may be an achievable pressure and may even be a vacuum pressure. By adjusting the pressure to such a level, the effect of suppressing the incorporation of void portions within the cured resin can be enhanced even further, as described later.

The viscosity of the curable resin 15′ at the time of application is preferably as low as possible within a range so that the application is not prevented, and more specifically, the viscosity is preferably from 20 to 3,000 mPa·s, and more preferably from 1,500 to 2,500 mPa·s. By adjusting the viscosity to such a level, even if the foreign material 8 is present in the coating-removed portion 10 or if the exposed end 13a of the second cladding layer has a rough surface, the curable resin 15′ easily flows into these recessed portion 80 and recessed portion 130, and the effect of suppressing formation of the void portion 7′ at the stage of applying the curable resin 15′ can be enhanced. Furthermore, since the curable resin 15′ easily flows into the recessed portion 80 and recessed portion 130, the time period from returning to the normal pressure to the carrying out of curing to be described later can also be shortened.

The viscosity of the curable resin 15′ can be adjusted by appropriately selecting the type of resin. Further, the viscosity may be adjusted by heating the curable resin 15′ at the time of application. The viscosity adjustment by heating is particularly suitable in view of increasing options for the usable curable resin 15′.

When heating the curable resin 15′, it is preferable to adjust the temperature so that the curable resin 15′ is not degraded or degenerated. Further, when the curable resin 15′ is a thermosetting resin, it is more preferable that the temperature be lower than the curing temperature. In addition, it is preferable to apply the curable resin 15′ while heating the temperature thereof at a temperature as described above. Note that the temperature at which the curable resin 15′ does not degrade or degenerate depends on the type of the resin. The temperature at which the curable resin 15′ is cured also depends on the type of the resin.

When applying the curable resin 15′ while heating the temperature thereof, the portion to hold the curable resin 15′ and/or the path to transfer the curable resin 15′ in the application apparatus may be thermally insulated until the application, or warm air may be blown onto the curable resin 15′ prior to the application.

In the recoating step, the aforementioned curable resin 15′ is then cured under normal pressure to form a recoat layer. In the present embodiment, by adjusting the pressure back to the normal pressure by releasing the reduced pressure prior to the curing of the curable resin 15′ in this manner, the void portions 7′ is filled with the curable resin 15′ and eliminated, as shown in FIG. 6B. This is due to the occurrence of pressure difference between the inside of the void portion 7′ which is kept under reduced pressure and the curable resin 15′ which is placed under normal pressure. In addition, by setting the pressure and viscosity of the curable resin 15′ at the time of application as described above, the void portion 7′ can be eliminated more easily.

The recoat layer can be formed by curing the curable resin 15′ by a suitable method depending on the type thereof. As a result, as shown in FIG. 6C, an optical fiber 1 in which the curable resin 15′ is formed into a recoat layer 15 can be obtained. As described above, according to the present embodiment, even if the foreign material 8 is present in the coating-removed portion 10 or if the exposed end 13a of the second cladding layer has a rough surface, since the incorporation of void portions in the recoat layer 15 can be suppressed, the loss of light can be reduced.

The time period from returning to the normal pressure to the carrying out of curing is not particularly limited as long as it is longer than the time required for eliminating the void portion 7′, in other words, the time required for filling the void portion 7′ with the curable resin 15′. However, it is preferable to adjust the time period appropriately by taking the viscosity of the curable resin 15′, the pressure at the time of decompression, the shape of the recessed portions 80 and 130, or the like into consideration. For example, the time period until the curing process may be somewhat long in those cases where the viscosity of the curable resin 15′ is high, the pressure at the time of decompression is somewhat high, and the shapes of the recessed portions 80 and 130 are complex (for example, when irregularities are present at the surface of the recessed portion). On the other hand, the time period may be shortened to some extent in those cases where the viscosity of the curable resin 15′ is low, the pressure at the time of decompression is somewhat low, and the shapes of the recessed portions 80 and 130 are simple (for example, when the surface of the recessed portion is smooth). In general, when the viscosity at a temperature of 25° C. is between 1,500 and 2,300 mPa·s and the pressure at the time of decompression is about 50 Pa or less, the time period from returning to the normal pressure to the carrying out of the curing is preferably from 2 to 30 minutes.

The refractive index of the recoat layer changes depending on the degree of curing of the curable resin 15′. Accordingly, it is preferable to adjust the degree of curing so as to achieve a desired refractive index, and in order to do so, it is preferable cure the curable resin 15′ while measuring the loss of propagating light in the first cladding layer 12. In addition, in general, it is preferable to cure the curable resin 15′ until the loss of propagating light in the first cladding layer 12 reaches zero or the minimum level.

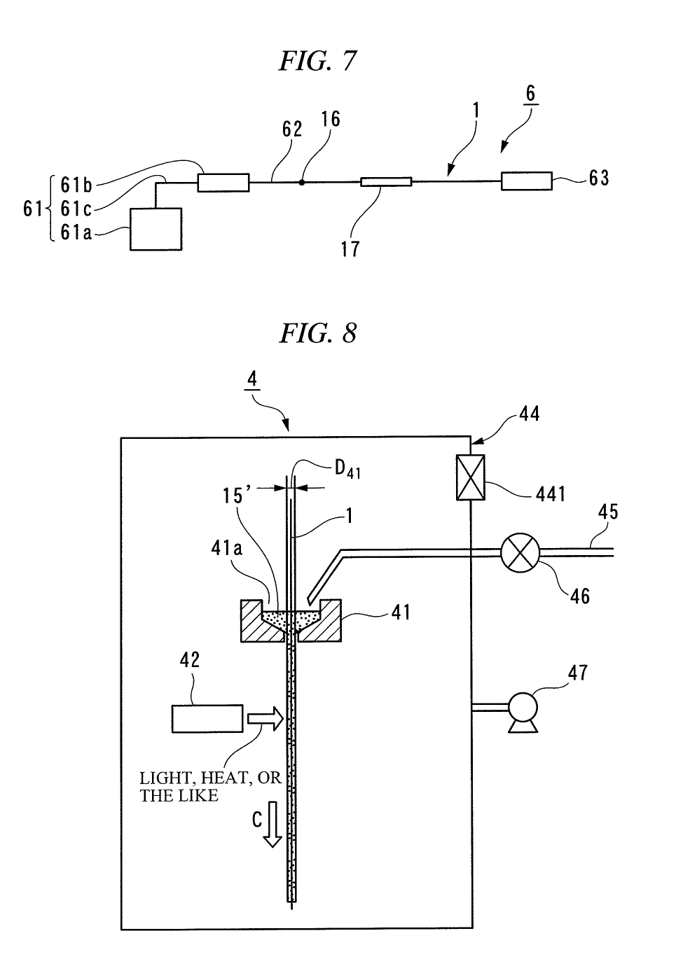

The loss of propagating light in the first cladding layer 12 can be measured by a measuring system for measuring the loss of light in the double clad optical fiber. FIG. 7 is a schematic configuration diagram showing such a measuring system.

A measuring system 6 exemplified herein is mainly constituted of a light source 61, a double clad optical fiber 1, a light detector 63 and an optical fiber 62.

In the light source 61, a laser diode controller 61a and a laser diode mount 61b are optically connected via an optical fiber 61c. Further, examples of the light detector 63 include a power meter. However, the light source and light detector are not limited thereto and can be selected appropriately if required. In addition, among these components, one end of the optical fiber 62 is optically connected to the laser diode mount 61b, and the other end of the optical fiber 62 is fused and optically connected to one end of the double clad optical fiber 1. The reference numeral 16 denotes a fused portion of the optical fiber 62 and the double clad optical fiber 1. Further, the other end of the optical fiber 1 is disposed opposite to a photometric section (not shown) of the light detector 63. As the light source 61 and the double clad optical fiber 1, a combination thereof is adopted, which takes numerical aperture (hereafter, abbreviated as NA) of the optical fiber into consideration so that light propagates the first cladding layer of the optical fiber 1. As the optical fiber 1 and the light detector 63, a combination thereof is adopted, which takes the NA into consideration so that all the light emitted from the other end of the optical fiber 1 is received by the light detector 63.

As described above, in the measuring system 6, it is configured so that the light irradiated from the light source 61 passes through a recoating section 17 of the optical fiber 1 and received by the light detector 63, and the loss of light in the optical fiber 1 can be verified by measuring the amount of light received.

The double clad optical fiber 1 in which a recoat layer is formed can be configured into a desired constitution by further coating the recoat layer with a protective coating layer.

The recoating step in those cases where (i) a die method, (ii) a molding method, and (iii) a casting method is employed will be described below in more detail.

### (i) Die Method

FIG. 8 is a schematic diagram for explaining a step of forming a recoat layer by employing a die method.

A recoating apparatus 4 exemplified herein includes a die 41 and a curing device 42 inside a vacuum chamber 44. The die 41 may be a type which is divided into half so that an optical fiber can be easily installed therein, or may be an integral type. In addition, an inner diameter D41 of a resin outlet port of a storage unit 41a may be made slightly larger than the outer diameter of the installed optical fiber. The curing device 42 may be selected in accordance with the type of the curable resin 15′, and examples thereof include a light source or a heat source. In addition, in the vacuum chamber 44, a vacuum pump 47 is connected thereto, a leak valve 441 is also provided, and moreover, the outside thereof is in communication with the inside thereof via a piping 45, and an end section of the piping 45 is disposed above the storage unit 41a of the die inside the chamber. Further, a valve 46 is interposed within the piping 45 so as to be positioned outside the vacuum chamber 44.

The double clad optical fiber 1 from which a coating has been removed is installed to the die 41. Then, the pressure inside the vacuum chamber 44 is reduced by operating the vacuum pump 47 at the time of closing the leak valve 441. The valve 46 is released in this state, and the curable resin 15′ is injected in the storage unit 41a of the die via the piping 45. After injecting the curable resin 15′, the valve 46 is closed, and by bringing down the double clad optical fiber 1 (in the direction indicated by the arrow C) at a certain speed by a driving device (not shown), the curable resin 15′ is applied on the surface 12a of the first cladding layer in the coating-removed portion 10.

Subsequently, the double clad optical fiber 1 is stopped, and the reduced pressure is released by opening the leak valve 441, thereby bringing the pressure inside the vacuum chamber 44 back to the normal pressure. Then, after a predetermined period of time, the curing device 42 is operated to cure the applied curable resin 15′, thereby forming a recoat layer.

### (ii) Molding Method

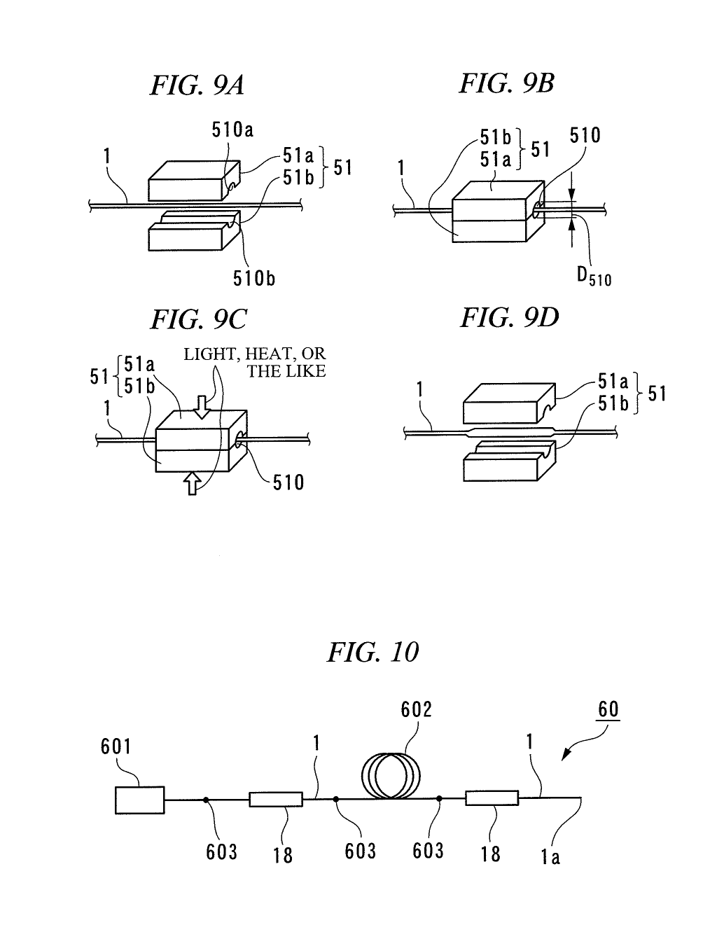

FIGS. 9A to 9D are schematic diagrams for explaining a step of forming a recoat layer by employing a molding method.

A mold 51 shown in FIGS. 9A to 9D is disposed instead of the die 41 inside the vacuum chamber 44 of the recoating apparatus 4 in FIG. 8. The mold 51 may be a commonly used mold, and constituted of an upper mold 51a and a lower mold 51b. An expanding slot 510a is formed in a joint surface (divided face) of the upper mold 51a, and an expanding slot 510b is also formed in the same manner in a joint surface of the lower mold 51b. These expanding slots 510a and 510b are aligned so as to form one through hole 510 at the time of joining the upper mold 51a and the lower mold 51b. The through hole 51 is for inserting an optical fiber therethrough and injecting a curable resin, and the length thereof in the central axis direction may be made somewhat longer than the length of the coating-removed portion 10 of the double clad optical fiber 1. In addition, the inner diameter D₅₁₀ of the through hole 510 may be the same as the above-mentioned inner diameter D41. It is preferable that the upper mold 51a and the lower mold 51b be constituted of a material exhibiting a light transmittance such as quartz glass when using a photocurable resin as a curable resin, and be constituted of a material exhibiting a high level of thermal conductivity such as a metal or an alloy when using a thermosetting resin as a curable resin. The curing device 42 may be arranged in the same manner as in the case of the recoating apparatus 4, or may be adjusted and arranged in accordance with the shape of the mold 51 so as to facilitate the curing, and examples of such arrangements include an opposing arrangement so as to sandwich the mold 51 therebetween.

In the molding method, as in the die method described above, the pressure inside the vacuum chamber is reduced and the coating-removed portion 10 is aligned with the expanding slots 510a and 510b, as shown in FIG. 9A, thereby installing the double clad optical fiber 1. Then, as shown in FIG. 9B, the upper mold 51a and the lower mold 51b are joined, and the curable resin 15′ is injected inside the through hole 510 through which the optical fiber 1 is inserted, thereby applying the curable resin 15′ on the surface 12a of the first cladding layer in the coating-removed portion 10.

Subsequently, the pressure inside the vacuum chamber 44 is brought back to the normal pressure, and after a predetermined period of time, the curing device 42 is operated to cure the applied curable resin 15′, as shown in FIG. 9C, thereby forming a recoat layer. Following formation of the recoat layer, as shown in FIG. 9D, the upper mold 51a and the lower mold 51b may be split to collect the double clad optical fiber 1.

(iii) Casting Method

In the casting method, a recoat layer may be formed by employing a commonly used die (not shown). A die having an inner diameter larger than the outer diameter of a double clad optical fiber and also a slot with a length in the central axis direction slightly longer than the length of the coating-removed portion of the double clad optical fiber is preferred. The material for the die may be the same as that for the aforementioned mold.

Further, by using a recoating apparatus, in which such a die is disposed instead of the die 41 inside the vacuum chamber 44 of the recoating apparatus 4 in FIG. 8, and aligning the coating-removed portion 10 with the slot, the double clad optical fiber 1 is installed inside the die. Subsequently, as in the aforementioned molding method, the pressure inside the vacuum chamber is reduced and the curable resin is injected to the slot in which the optical fiber is installed, thereby applying the curable resin on the surface of the first cladding layer in the coating-removed portion. Then, as in the aforementioned molding method, the pressure inside the vacuum chamber is brought back to the normal pressure, and after a predetermined period of time, the applied curable resin is cured, thereby forming a recoat layer.

The loss of light in the double clad optical fiber which has been recoated can be measured by employing the aforementioned measuring system 6.

The recoating method according to the present embodiment can be applied, for example, for recoating a Fiber Bragg Grating (hereafter, abbreviated as FBG) for constructing a fiber laser resonator. Although the FBG can be prepared, for example, by removing the coating of a double clad optical fiber followed by irradiation of ultraviolet light to the coating-removed portion, recoating of the coating-removed portion is necessary in order to maintain the strength or optical properties, and the recoating method according to the present embodiment can be suitably applied thereto.

In addition, the recoating method according to the present embodiment can also be applied for connecting the double clad optical fibers to each other or for connecting a double clad optical fiber to another type of optical fiber. Such connection of optical fibers is usually carried out by fusing the ends of the optical fibers. However, at the time of fusion, removal of the coating layer is necessary, and thus a fused portion has no coating layer. Accordingly, recoating is necessary in order to maintain the strength or optical properties of the fused portion, and the recoating method according to the present embodiment can be suitably applied thereto.

In the FBG or fused portion which is recoated by the recoating method according to the present embodiment, the loss of light in the recoated portion is reduced, and the excitation light of fiber laser which propagates through the first cladding layer can be used efficiently.

FIG. 10 is a schematic configuration diagram showing a cladding pumped fiber laser prepared by employing the recoating method according to the present embodiment for recoating the FBG or connecting portion as described above.

A fiber laser 60 exemplified herein is mainly constituted of the optical fiber 1 that includes an FBG 18, an excitation laser diode 601 and an optical fiber for amplification 602. Further, both ends of the optical fiber for amplification 602 are each fused and optically connected with one end of the optical fiber 1 at both sides, and the other end of the optical fiber 1 on one side which is not fused with the optical fiber for amplification 602 is fused and optically connected with the excitation laser diode 601. In addition, the other end of the optical fiber 1 on the other side which is not fused with the optical fiber for amplification 602 emits laser emitting light 1a. The reference numeral 603 denotes the fused portion of the optical fiber 1 and the optical fiber for amplification 602, or the fused portion of the optical fiber 1 and the excitation laser diode 601. Further, the fused portion 603 and the FBG 18 are recoated by the method according to the above-described embodiment.

### EXAMPLES

The present embodiment will be described below in more detail with reference to specific examples. However, the present embodiment is in no way limited by the examples shown below.

### Examples 1 to 9

A recoating process was carried out by the procedures described below by employing a double clad optical fiber having a cross section shown in FIG. 1 and including a core and a first cladding layer which consist primarily of quartz glass, a second cladding layer constituted of a fluorinated acrylate resin having a refractive index lower than that of the first cladding layer, and a protective coating layer constituted of an urethane acrylate resin. Note that the outer diameter of the first cladding layer of the optical fiber was 125 μm and the outer diameter of the protective coating layer was 250 μm.

Nine sets of the above-mentioned double clad optical fibers which were cut so that the length thereof in the longitudinal direction was 5 m were prepared.

Subsequently, those in which the second cladding layer and the protective coating layer were removed (removal step) were prepared in three sets, each set prepared by one of the following methods; i.e., (a) removal by laser irradiation, (b) removal by blowing of hot air, and (c) removal by cutting using a cutting tool. More specific explanations therefor are as follows.

### <Recoating of Double Clad Optical Fiber>

### (Removal Step)

### (a) Removal by Laser Irradiation

A KrF excimer laser having a wavelength of 248 nm was irradiated onto the double clad optical fiber using the laser irradiating apparatus shown in FIG. 3. The intensity of the irradiated laser beam was 0.78 mJ/cm². The laser was irradiated by fixing the double clad optical fiber while moving a stage along the longitudinal direction of the fiber at a rate of 0.05 mm/sec for 600 seconds. Further, the fiber was rotated by 90° in the outer circumferential direction thereof, and the laser was then irradiated in the same manner. The same operation was repeated for two more times, and the laser was irradiated from the total of four directions, each differed by 90°, thereby removing all the second cladding layer and the coating layer within the irradiated section. As a result, resin residues with fine irregularities were present in the surface of the first cladding layer and the surface of the exposed end of the second cladding layer within the coating-removed portions, and the exposed end of the second cladding layer also had a rough surface.

### (b) Removal by Blowing Hot Air

A coating layer was removed by blowing a hot air of 850° C. onto the double clad optical fiber using a hot air blowing apparatus shown in FIG. 4. The rate of the blown hot air was adjusted to 250 L/min. The hot air was blown by fixing the double clad optical fiber while moving a nozzle along the longitudinal direction of the fiber at a rate of 10 mm/sec for 3 seconds. The hot air was blown from one direction only, and all the second cladding layer and the coating layer within the blown section was removed. As a result, resin residues with fine irregularities were present in the surface of the first cladding layer within the coating-removed portions, and the exposed end of the second cladding layer also had a rough surface.

### (c) Removal by Cutting Using a Cutting Tool

All the second cladding layer and the coating layer were removed within a predetermined section in the longitudinal direction of the double clad optical fiber by a manual operation using a single edged razor blade. As a result, as in the case of the above-mentioned removal method (a), resin residues with fine irregularities were present in the surface of the first cladding layer and the surface of the exposed end of the second cladding layer within the coating-removed portions, and the exposed end of the second cladding layer also had a rough surface.

A recoat layer was formed on each of the coating-removed portions of the double clad optical fibers treated by the above-mentioned methods (a) to (c) by employing (i) a die method, (ii) a molding method, and (iii) a casting method. More specific explanations therefor are as follows.

### (Recoating Step)

### (i) Die Method

A recoat layer was formed using a recoating apparatus shown in FIG. 8. A die made of stainless steel and having an inner diameter D41 of 260 μm was used. In addition, a fluorinated acrylate resin which was an ultraviolet curable resin was used as a curable resin, and this was applied at a room temperature (which was 24° C.), and a mercury lamp which was a UV light source was used as a curing device. The pressure inside the vacuum chamber was reduced to 10 Pa using a rotary pump. Then, five minutes after releasing the reduced pressure and bringing back the normal pressure, the mercury lamp was lit, thereby starting the curing of the resin. Completion of the curing of the resin was visually determined. As a result, the UV light irradiation time was 150 seconds.

### (ii) Molding Method

A recoat layer was formed using a recoating apparatus shown in FIGS. 9A to 9D. A mold made of quartz glass and having an inner diameter D510 of 260 μm was used. In addition, a fluorinated acrylate resin which was an ultraviolet curable resin was used as a curable resin, and this was applied at a room temperature (which was 24° C.), and a mercury lamp which was a UV light source was used as a curing device. The pressure inside the vacuum chamber was reduced to 10 Pa using a rotary pump. Then, five minutes after releasing the reduced pressure and bringing back the normal pressure, the mercury lamp was lit, thereby starting the curing of the resin. Completion of the curing of the resin was visually determined. As a result, the UV light irradiation time was 160 seconds.

(iii) Casting Method

A recoat layer was formed using a cylindrical die having an inner diameter of 1 mm and made of quartz glass. A fluorinated acrylate resin which was an ultraviolet curable resin was used as a curable resin, and this was applied at a room temperature (which was 24° C.), and a mercury lamp which was a UV light source was used as a curing device. The pressure inside the vacuum chamber was reduced to 10 Pa using a rotary pump. Then, five minutes after releasing the reduced pressure and bringing back the normal pressure, the mercury lamp was lit, thereby starting the curing of the resin. Completion of the curing of the resin was visually determined. As a result, the UV light irradiation time was 600 seconds.

### <Measurement of Transmitted Light Power in the Recoated Double Clad Optical Fiber>

The loss of light in the double clad optical fiber which had been recoated was measured by employing a measuring system shown in FIG. 7. A light source including a laser diode having a wavelength of 980 nm was used, and a power meter was used as a light detector.

First, the power of transmitted light in the aforementioned nine types of recoated double clad optical fibers was measured and the measured value was defined as P₀. Subsequently, the double clad optical fiber was cut in the vicinity of the intermediate point between the fused portion 16 and the recoating portion 17, and the power of transmitted light was then measured and the measured value was defined as P₁. Then, the loss of light at the cut portion calculated by the formula “P_{LOSS}=P₀−P₁” was each determined for the aforementioned nine types of optical fibers. The “P_{LOSS}” values also include the loss of light due to the transmission loss by the double clad optical fiber itself in addition to the loss of light in the coating-removed portion and the recoating portion. However, the double clad optical fibers provided for the measurement had a length of 5 m, and the loss of light due to the aforementioned transmission loss with such a short length is sufficiently low as compared to the loss of light in the coating-removed portion and the recoating portion, and is thus negligible. Therefore, the “P_{LOSS}” values can be regarded as equivalent to the “loss of light in the coating-removed portion and the recoating portion”.

The calculated results for P_{LOSS} values by this method are shown in Table 1.

### Comparative Examples 1 to 9

A recoating process was carried out and the P_{LOSS} values were calculated in the same manner as that in Examples 1 to 9 with the exception that in the recoating step, the curable resin was applied on the surface of the first cladding layer under normal pressure without reducing the pressure, and the curing was started immediately after the application. The calculated results are shown in Table 1.

As is apparent from the results shown in Table 1, in Examples 1 to 9 where the curable resin was applied under reduced pressure, the loss of light was reduced to 0.08 dB or less, regardless of the method of removing the coating layer or the method of forming the recoat layer. On the other hand, in Comparative Examples 1 to 9 where the curable resin was applied under normal pressure without reducing the pressure, it was not possible to reduce the loss of light, which was 0.52 dB or more.

### Examples 10 to 18

A recoating process was carried out and the P_{LOSS} values were calculated in the same manner as that in Examples 1 to 9 with the exception that the curable resin was applied on the surface of the first cladding layer while heating the temperature thereof at 60° C. by providing an electric heater in a die, a mold or a die and heating it with the heater. The calculated results are shown in Table 1. Note that it has been confirmed that degeneration such as curing or degradation did not occur at 60° C. in the fluorinated acrylate resin which was used as a curable resin.

As is apparent from the results shown in Table 1, in Examples 10 to 18 where the curable resin was applied while heating the temperature thereof at 60° C., the loss of light was further reduced, as compared to Examples 1 to 9 where the curable resin was applied at room temperature. It is thought that even if the foreign material was present in the coating-removed portion or the exposed end of the second cladding layer had a rough surface, and thus recessed portions were present therein, the thermally insulated curable resin easily flowed into the recessed portions, thereby suppressing the occurrence of void portions.

TABLE 1

| | Removal step | Recoating step | P_{LOSS} |
|---|---|---|---|
| | (Removal method) | (Pressure/Temperature/Resin application method) | (dB) |
| Ex. 1 | (a) Laser irradiation | Reduced pressure/Room temperature/(i) Die method | 0.07 |
| Ex. 2 | (a) Laser irradiation | Reduced pressure/Room temperature/(ii) Molding method | 0.06 |
| Ex. 3 | (a) Laser irradiation | Reduced pressure/Room temperature/(iii) Casting method | 0.06 |
| Ex. 4 | (b) Blowing of hot air | Reduced pressure/Room temperature/(i) Die method | 0.05 |
| Ex. 5 | (b) Blowing of hot air | Reduced pressure/Room temperature/(ii) Molding method | 0.05 |
| Ex. 6 | (b) Blowing of hot air | Reduced pressure/Room temperature/(iii) Casting method | 0.05 |
| Ex. 7 | (c) Cutting tool | Reduced pressure/Room temperature/(i) Die method | 0.08 |
| Ex. 8 | (c) Cutting tool | Reduced pressure/Room temperature/(ii) Molding method | 0.06 |
| Ex. 9 | (c) Cutting tool | Reduced pressure/Room temperature/(iii) Casting method | 0.07 |
| Ex. 10 | (a) Laser irradiation | Reduced pressure/60° C./(i) Die method | 0.05 |
| Ex. 11 | (a) Laser irradiation | Reduced pressure/60° C./(ii) Molding method | 0.04 |
| Ex. 12 | (a) Laser irradiation | Reduced pressure/60° C./(iii) Casting method | 0.04 |
| Ex. 13 | (b) Blowing of hot air | Reduced pressure/60° C./(i) Die method | 0.04 |
| Ex. 14 | (b) Blowing of hot air | Reduced pressure/60° C./(ii) Molding method | 0.04 |
| Ex. 15 | (b) Blowing of hot air | Reduced pressure/60° C./(iii) Casting method | 0.04 |
| Ex. 16 | (c) Cutting tool | Reduced pressure/60° C./(i) Die method | 0.06 |
| Ex. 17 | (c) Cutting tool | Reduced pressure/60° C./(ii) Molding method | 0.04 |
| Ex. 18 | (c) Cutting tool | Reduced pressure/60° C./(iii) Casting method | 0.05 |
| Comp. Ex. 1 | (a) Laser irradiation | Normal pressure/Room temperature/(i) Die method | 0.63 |
| Comp. Ex. 2 | (a) Laser irradiation | Normal pressure/Room temperature/(ii) Molding method | 0.60 |
| Comp. Ex. 3 | (a) Laser irradiation | Normal pressure/Room temperature/(iii) Casting method | 0.61 |
| Comp. Ex. 4 | (b) Blowing of hot air | Normal pressure/Room temperature/(i) Die method | 0.52 |
| Comp. Ex. 5 | (b) Blowing of hot air | Normal pressure/Room temperature/(ii) Molding method | 0.54 |
| Comp. Ex. 6 | (b) Blowing of hot air | Normal pressure/Room temperature/(iii) Casting method | 0.56 |
| Comp. Ex. 7 | (c) Cutting tool | Normal pressure/Room temperature/(i) Die method | 0.69 |
| Comp. Ex. 8 | (c) Cutting tool | Normal pressure/Room temperature/(ii) Molding method | 0.71 |
| Comp. Ex. 9 | (c) Cutting tool | Normal pressure/Room temperature/(iii) Casting method | 0.74 |

### Examples 19

A recoating process was carried out by the procedures described below by employing a double clad optical fiber having a cross section shown in FIG. 1 and including a core and a first cladding layer which consist primarily of quartz glass, a second cladding layer constituted of a fluorinated acrylate resin having a refractive index lower than that of the first cladding layer, and a protective coating layer constituted of an urethane acrylate resin. Note that the outer diameter of the first cladding layer of the optical fiber was 125 μM and the outer diameter of the protective coating layer was 250 μm.

The above-mentioned double clad optical fiber was installed to a Peltier device serving as a cooling device via a metal plate serving as a heat conductor as shown in FIG. 5. Then, the double clad optical fiber was cooled by keeping the temperature of the metal plate to 10° C. using the Peltier device, and a KrF excimer laser having a wavelength of 248 nm was irradiated onto the double clad optical fiber using the laser irradiating apparatus shown in FIG. 3. The intensity of the irradiated laser beam was 0.78 mJ/cm². The laser was irradiated by fixing the double clad optical fiber while moving a stage along the longitudinal direction of the fiber at a rate of 0.05 mm/sec for 600 seconds. Further, the fiber was rotated by 90° in the outer circumferential direction thereof, and the laser was then irradiated in the same manner. The same operation was repeated for two more times, and thus the laser was irradiated from the total of four directions, each differed by 90°, thereby removing all the second cladding layer and the coating layer within the irradiated section (removal step).

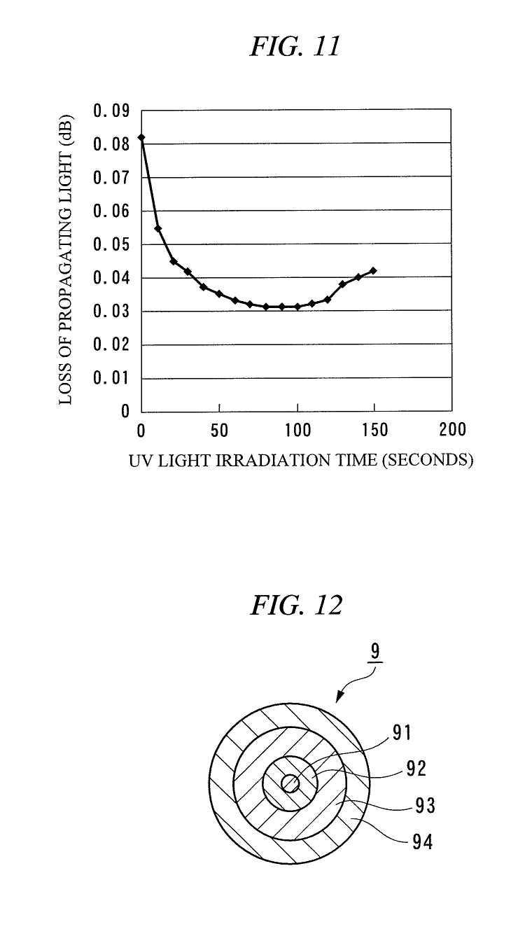

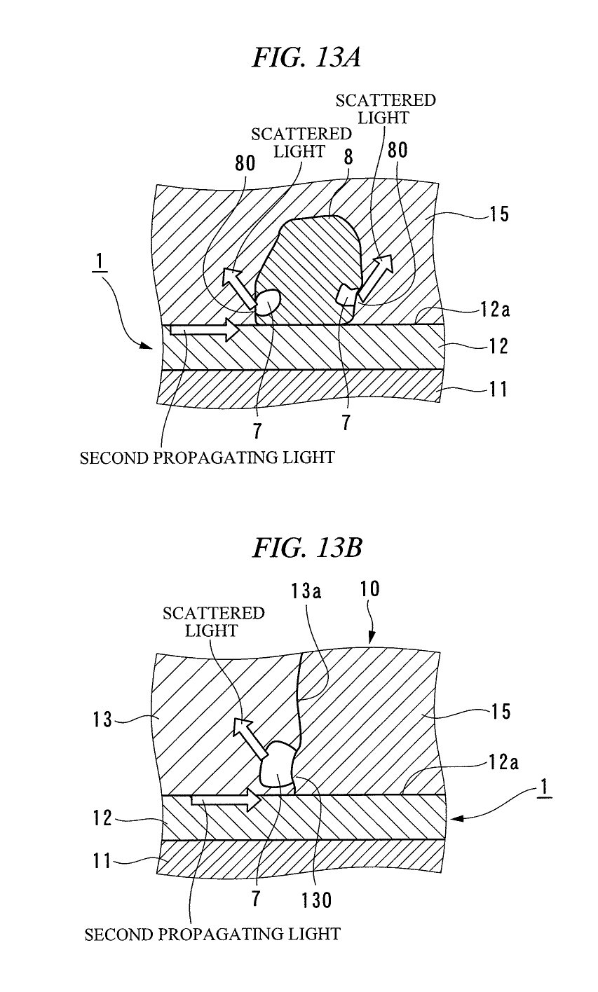

Subsequently, a recoat layer was formed on the coating-removed portion of the double clad optical fiber by the die method (i) in the same manner as that in Example 1 using a recoating apparatus shown in FIG. 8 (recoating step). That is, a die made of stainless steel and having an inner diameter D41 of 260 μm was used. In addition, a fluorinated acrylate resin which was an ultraviolet curable resin was used as a curable resin, and this was applied at a room temperature (which was 24° C.), and a mercury lamp which was a UV light source was used as a curing device. The pressure inside the vacuum chamber was reduced to 10 Pa using a rotary pump. Further, during the curing of the resin, it was configured so that the loss of propagating light in the first cladding layer can be measured using a measuring system as shown in FIG. 7. Then, five minutes after releasing the reduced pressure and bringing back the normal pressure, the mercury lamp was lit, the curing of the resin was started, and the resin was cured while measuring the loss of light. The relationship between the UV light irradiation time and the loss of propagating light in the first cladding layer had been examined using the same optical fiber in advance. The results thereof are shown in FIG. 11. As is evident from FIG. 11, it was confirmed that as the UV light irradiation time increased, the loss of light reduced, and then the loss of light started to increase. Accordingly, in the present example, the resin was cured while measuring the loss of light, and the mercury lamp was swiftly turned off to terminate the curing at the stage where the loss of light started to increase, so that the loss of light was minimal.

Subsequently, the P_{LOSS} value was calculated. As a result, it was possible to reduce the loss of light to an extremely low level, which was 0.03 dB.

### Reference Example 1

A recoating process was carried out and the P_{LOSS} value was calculated in the same manner as that in Example 19 with the exception that the double clad optical fiber was not cooled in the removal step, and the ultraviolet curable resin (fluorinated acrylate resin) was applied on the surface of the first cladding layer under normal pressure without reducing the pressure in the recoating step. As a result, the P_{LOSS} value was 0.45 dB.

### Comparative Example 10

A recoating process was carried out and the P_{LOSS} value was calculated in the same manner as that in Example 19 with the exception that the double clad optical fiber was not cooled in the removal step, and, in the recoating step, the ultraviolet curable resin (fluorinated acrylate resin) was applied on the surface of the first cladding layer under normal pressure without reducing the pressure, and the completion of the curing of the resin was visually determined. This operation was repeated 10 times. As a result, the average of the P_{LOSS} values was 0.60 dB.

While a preferred embodiment of the invention has been described and illustrated above, it should be understood that this is exemplary of the invention and is not to be considered as limiting. Additions, omissions, substitutions, and other modifications can be made without departing from the scope of the present invention. Accordingly, the invention is not to be considered as being limited by the foregoing description, and is only limited by the scope of the appended claims.

1. A method for recoating a double clad optical fiber having a core, a first cladding layer that surrounds the core, and a coating layer that covers the first cladding layer, in which the coating layer includes a second cladding layer that surrounds the first cladding layer, the method comprising:
a step of removing the coating layer and exposing the first cladding layer; and
a step of applying a curable resin on top of the exposed first cladding layer under reduced pressure, followed by curing of the curable resin under normal pressure, thereby forming a recoat layer.

2. The method for recoating a double clad optical fiber according claim 1,
wherein the curable resin is applied on top of the first cladding layer while heating the curable resin at a temperature so as not to degrade or degenerate.

3. The method for recoating a double clad optical fiber according to claim 1, wherein the curable resin is cured while measuring a loss of a propagating light in the first cladding layer.

4. The method for recoating a double clad optical fiber according to claim 1, wherein the coating layer is removed by laser irradiation.

5. The method for recoating a double clad optical fiber according to claim 1, wherein the coating layer is removed while cooling to a temperature at which the second cladding layer does not degenerate.

6. The method for recoating a double clad optical fiber according to claim 1, wherein the curable resin is an ultraviolet curable resin and the second cladding layer is formed by curing an ultraviolet curable resin.

7. The method for recoating a double clad optical fiber according to claim 1, wherein the recoat layer is formed by a molding method, a die method or a casting method.
